(19) United States
(12) Patent Application Publication
(10) Pub. No.: US 2024/0278505 A1
(43) Pub. Date: Aug. 22, 2024

(54) PROGRAMMATIC DETERMINATION OF REINFORCEMENT MATERIAL FOR 3D PRINTING

(71) Applicant: INTERNATIONAL BUSINESS MACHINES CORPORATION, ARMONK, NY (US)

(72) Inventors: Jeremy R. Fox, Georgetown, TX (US); Tushar Agrawal, West Fargo, ND (US); Sarbajit K. Rakshit, Kolkata (IN)

(21) Appl. No.: 18/172,607

(22) Filed: Feb. 22, 2023

(51) Int. Cl. B29C 64/393; B29C 64/209

(52) U.S. Cl. CPC B29C 64/393; B29C 64/209; B33Y 10/00; B33Y 50/02

(57) ABSTRACT

According to one embodiment, a method, computer system, and computer program product for 3D printing is provided. The present invention may include analyzing a digital model of a 3D object; identifying stresses expected to be applied to the 3D object; performing digital twin simulation of the 3D object; simulating the identified stresses on the 3D object; determining one or more reinforcement materials for the 3D object based on the simulating of the identified stresses on the 3D object; modifying the digital model of the 3D object to include the one or more determined reinforcement materials; and printing the one or more determined reinforcement materials on and/or in the 3D object.

### BACKGROUND

The present invention relates, generally, to the field of computing, and more particularly to 3D printing.

3D printing is a technology that is used to construct a three-dimensional (3D object) from a digital 3D model. 3D printing is performed in processes in which material is deposited, and joined or solidified under computer control, with material typically being added together layer by layer. Currently, 3D printing can be performed using reinforcement material, thus, enhancing the physical properties of a 3D printed object. However, in order for true optimization of the 3D printing process, a method and system by which an appropriate type and amount of reinforcement materials are printed on and/or in a 3D printed object, are needed. Thus, an improvement in 3D printing has the potential to benefit a user, the 3D printing process, and 3D printed products by maximizing the lifespan of a 3D printed product, reducing waste, and optimizing print time.

### SUMMARY

According to one embodiment, a method, computer system, and computer program product for 3D printing is provided. The present invention may include analyzing a digital model of a 3D object; identifying stresses expected to be applied to the 3D object; performing digital twin simulation of the 3D object; simulating the identified stresses on the 3D object; determining one or more reinforcement materials for the 3D object based on the simulating of the identified stresses on the 3D object; modifying the digital model of the 3D object to include the one or more determined reinforcement materials; and printing the one or more determined reinforcement materials on and/or in the 3D object.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary application invention environment according to at least one embodiment;

FIG. 3 is an operational flowchart illustrating a 3D printed object reinforcement material determination process according to at least one embodiment; and

FIG. 4 is a system diagram illustrating an exemplary program environment of an implementation of a 3D printed object reinforcement material determination process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

In 3D printing, a 3D object may be created by laying down successive layers of material until the object is created. Reinforcement materials may be used to enhance the strength of a 3D object to improve its durability, increase rigidity, and impede crack propagation. While there are many types of reinforcement material, a person may have trouble determining the quantity of reinforcement material to use and where to use it on the 3D object since multiple types of material can be mixed for reinforcement. Therefore, optimizing the 3D printing process may be limited by incorrect usage of the reinforcement materials. As a result, the 3D object may perform less effectively and ultimately cost more because of the possible need to remake the 3D object or from using an incorrect amount or incorrect type of reinforcement material.

One way in which current methods attempt to address problems with determining the quantity of reinforcement material to use on a 3D object is by processing a computer model of a 3D object to generate a stress profile of the computer model. Generating a stress profile of a computer model of a 3D object allows for determining a certain quantity of reinforcement material to use on a 3D object. However, one of the deficiencies of the current method is that the method can only determine a certain quantity of reinforcement material to use on a 3D object as a whole, and not a certain quantity of reinforcement material needed for specific areas on the 3D object. Different types and magnitudes of force are applied to a 3D object from multiple directions. Thus, it is important that an appropriate amount of reinforcement material is added to each specific area of a 3D object that is determined to require more support. Thus, improving the 3D printing process has the potential to maximize the lifespan of the 3D printed object, optimize the time required for printing, and reduce wasted material.

The present invention has the capacity to improve 3D printing by using digital twin simulation to simulate different stresses on a 3D object to be printed to determine the type(s) and quantity(ies) of reinforcement materials to print on or in a 3D object. The program can determine the type(s) and quantity(ies) of reinforcement materials to print on or in a 3D object so that the 3D object can withstand the expected stresses that will be applied to the 3D object over its lifespan. This improvement in 3D printing can be accomplished by implementing a system that analyzes a digital model of a 3D object, identifies stresses expected to be applied to the 3D object, performs digital twin simulation of the 3D object, simulates the identified stresses on the 3D object, determines one or more reinforcement materials for the 3D object based on the simulation of the identified stresses on the 3D object, modifies the digital model of the 3D object to include the one or more determined reinforcement materials, and prints the one or more determined reinforcement materials on and/or in the 3D object.

In some embodiments of the invention, the 3D printed object reinforcement material determination program, herein referred to as “the program”, can perform a digital twin simulation of a 3D printed object to determine the type(s) and quantity(ies) of reinforcement materials to print on or in a 3D object so that the 3D object will be able to withstand certain applied stresses over a certain period, such as the expected lifespan of the 3D object. Applied stresses may comprise the types of stresses that the 3D object is expected to experience, the direction of the stresses, and the magnitude of the stresses, over the course of the 3D object's lifetime. The program can import the digital model of the 3D object into the digital twin simulation, herein referred to as the digital twin 3D object model. A digital twin 3D object model may comprise the same properties as the digital model of the 3D object. The program may dynamically modify a digital model of the 3D model based on the modifications made to the digital twin 3D object model during the digital twin simulation. Reinforcement materials may comprise types of composite material, such as metal chips, metal blocks, rubber, carbon nanotube, graphene, etc. A reinforcement material may be individually printed on and/or in a 3D object. The program can import the digital model of the 3D object into the digital twin simulation, herein referred to as the digital twin 3D object model. A digital twin 3D object model may comprise the same properties as the digital model of the 3D object. The program may dynamically modify a digital model of the 3D model based on the modifications made to the digital twin 3D object model during the digital twin simulation.

The program can simulate the identified applied stresses on the 3D object. The program can simulate the identified applied stresses on the digital twin 3D object model with the digital twin 3D object comprising one or more reinforcement materials from one or more reinforcement templates. A reinforcement template may comprise different types of reinforcement materials and/or a combination of reinforcement materials. Reinforcement template(s) may be uploaded to the program by a user. Reinforcement templates may be crowdsourced, based on a manufacturer's recommendations, based on industry standards, and modified by users. Additionally, a reinforcement template may comprise the usage history of the template and positive/negative ratings from users based on previous usage via a user's response to a prompt on the GUI after the completion of the 3D printing of an object. Additionally, reinforcement templates may be associated with certain cost parameters, and/or weight parameters. Additionally, reinforcement templates may comprise using a multi-nozzle system and/or mixing chamber. The program can simulate the identified stresses on the digital twin 3D object model comprising the addition(s) of the reinforcement material(s) in the chosen reinforcement template.

The program can modify the digital model of the 3D object to comprise the one or more determined reinforcement materials. The program may modify the digital model of the 3D object based on the modification(s) to the digital twin 3D object model during the digital twin simulation. The program can dynamically save the data representing the modifications and the digital model of the 3D object comprising the modifications in the database. The digital twin simulation can identify which reinforcement templates were used successfully to withstand the simulated identified applied stresses that the 3D object is expected to receive over a certain period, such as the 3D object's lifespan. Additionally, the digital twin simulation may identify the target areas of the 3D object to strengthen or a change in filament(s) type. The program may dynamically modify the digital twin 3D object model to comprise the one or more reinforcement materials based on the successful reinforcement template. If more than one reinforcement template is successful, the program may display the results to the user via a prompt on the GUI. The displayed results may comprise an image of the modified digital twin 3D object, cost of reinforcement materials, amount and types of reinforcement materials used, and filaments needed. A user may select the reinforcement template to implement into the digital twin 3D object model. The program may modify the digital twin 3D object model to comprise the one or more reinforcement materials in the chosen successful reinforcement template.

The program can send the modified digital model of the 3D object to the 3D printer(s). The program may perform a programmatic reinforcement printing method to print the 3D printed object. The program can control and leverage a multi-nozzle system in a 3D printer(s) to perform 3D printing. The multi-nozzle system may comprise one or more 3D printing nozzles, an inject jet, a mixing container, and a spray nozzle. The program can instruct the nozzles in the multi-nozzle system separately, partially, or together. The program may instruct the times at which the nozzles will print, such that the nozzles can print at the same or different times, and the order in which the nozzles will print. Multiple printing nozzles may be used to print various reinforcement materials through the use of different individual filaments and/or filament mixtures loaded into each printing nozzle. In some embodiments of the invention, multiple types of reinforcement materials may be mixed in the 3D printer's mixing chamber and may be printed in a mixture. Additionally, in some embodiments of the invention, the program may insert a metal wire strip through a portion of the 3D object by using an inject jet. In some embodiments of the invention, the program may use multiple 3D printers to print the one or more determined reinforcement materials on or in the 3D object. The program may feed the data representing the modified digital model of the 3D object to the 3D printer(s) with instructions instructing the 3D printer(s) to print the one or more determined reinforcement materials on or in the 3D object.

The program can analyze a digital model of a 3D object, such as a CAD file, to determine the dimensions, shape, and/or the axis of an object being 3D printed. A user may select a CAD model from the client computing device and/or database for the program to analyze. The program can generate a digital model of the 3D object based on the analyzed CAD model of the 3D object. Additionally, the program can analyze the stress profile of the object being printed to determine the operational and environmental parameters of the 3D object. A digital model of a 3D object can comprise a stress profile. The stress profile of the 3D object can comprise information related to the stresses that are expected to be applied to the 3D object, such as why, when, what, and how the 3D object will be used, and the operational and environmental parameters of the 3D object. Operational parameters may comprise the types of activities the 3D object is expected to perform, and how long the 3D object is expected to perform an activity, etc. Environmental parameters may comprise information relating to the 3D object's surroundings, like temperature and humidity, etc. The program can identify the stresses that are expected to be applied to the 3D object, also referred to as the identified applied stresses, based on the expected operational and environmental parameters of the 3D object.

In some embodiments of the invention, the program may evaluate the cost of the one or more determined reinforcement materials in the successful reinforcement templates to the 3D object. The program may compare the costs of using each successful reinforcement template to one another and may select the cheapest successful reinforcement template to use. Alternatively, if the cost of using a certain reinforcement template is determined to be too costly, based on a user's response to a prompt on the graphical user interface, the program may determine if an alternate selection of reinforcement materials is available to be printed on or in the 3D object instead using a trial and error method in the digital twin simulation. The trial and error method may comprise the program simulating different combinations of reinforcement material(s) in or on the 3D object to determine if one or more different combinations of reinforcement material(s) can be applied to the 3D object so that the 3D object can withstand the identified applied stresses. If the program determines that using an alternate selection of reinforcement material(s) is appropriate, the program may implement the alternate selection of reinforcement materials into the digital twin 3D object model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to analyze a digital model of a 3D object, identify stresses expected to be applied to the 3D object, perform digital twin simulation of the 3D object, simulate the identified stresses on the 3D object, determine one or more reinforcement materials for the 3D object based on the simulation of the identified stresses on the 3D object, modify the digital model of the 3D object to include the one or more determined reinforcement materials, and print the one or more determined reinforcement materials on and/or in the 3D object.

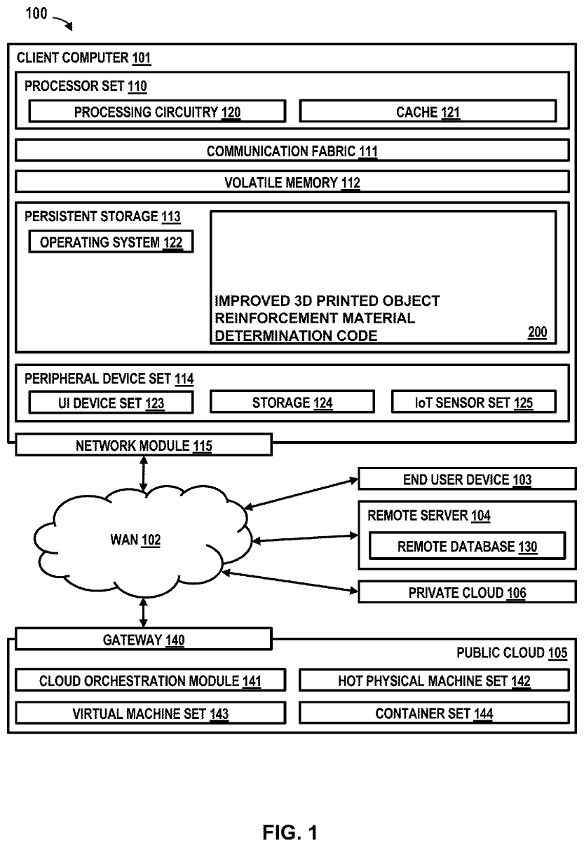

Referring to FIG. 1, an exemplary networked computer environment 100 is depicted, according to at least one embodiment. Computing environment 100 contains an example of an environment for the execution of at least some of the computer code involved in performing the inventive methods, such as improved 3D printed object reinforcement material determination code 200. In addition to code block 200 computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

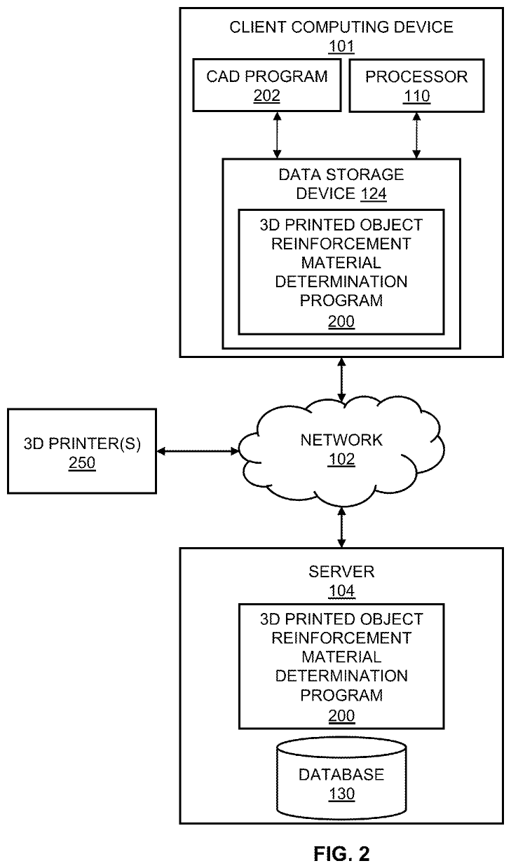

Referring to FIG. 2, an exemplary application environment is depicted, according to at least one embodiment. FIG. 2 may include client computing device 101 and a remote server 104 interconnected via a communication network 102. According to at least one implementation, FIG. 2 may include a plurality of client computing devices 101 and remote servers 104, of which only one of each is shown for illustrative brevity. It may be appreciated that FIG. 2 provides only an illustration of one implementation and does not imply any limitations with regard to the environments in which different embodiments may be implemented. Many modifications to the depicted environments may be made based on design and implementation requirements.

Client computing device 101 may include a processor 110 and a data storage device 124 that is enabled to host and run a 3D printed object reinforcement material determination program 200 and communicate with the remote server 104 via the communication network 102, in accordance with one embodiment of the invention. Client computing device 101 may include a computer-aided design (CAD) program 202. CAD program 202 can be any program capable of creating two-dimensional drawings and/or three-dimensional models.

The remote server computer 104 may be a laptop computer, netbook computer, personal computer (PC), a desktop computer, or any programmable electronic device or any network of programmable electronic devices capable of hosting and running a 3D printed object reinforcement material determination program 200 and a database 130 and communicating with the client computing device 101 via the communication network 102, in accordance with embodiments of the invention. The remote server 104 may also operate in a cloud computing service model, such as Software as a Service (SaaS), Platform as a Service (PaaS), or Infrastructure as a Service (IaaS). The remote server 104 may also be located in a cloud computing deployment model, such as a private cloud, community cloud, public cloud, or hybrid cloud.

The database 130 may be a digital repository capable of data storage and data retrieval. The database 130 can be present in the remote server 104 and/or any other location in the network 102. The database 130 can store 3D digital models and the information outputted from the CAD module 406. The database 130 may comprise a knowledge corpus. The knowledge corpus may comprise data relating to the types of reinforcement materials, combinations of reinforcement materials, reinforcement materials in relation to their use in 3D objects, for example, how a reinforcement material reacts to being printed on a certain metal, the usual cost of the reinforcement material, etc. The knowledge corpus may comprise reinforcement templates. The knowledge corpus may comprise data relating to stresses that are applied to a 3D object(s), such as the various magnitudes that the stress is applied to a 3D object, the lengths at that the stress has been applied to a 3D object, etc. Additionally, the knowledge corpus may comprise data relating to 3D objects, and the types, directions, and magnitudes of stresses that are applied to the 3D objects. Additionally, the knowledge corpus may comprise the stress profiles of 3D objects. A stress profile of a 3D object may comprise data related to the operational and environmental parameters of a 3D object, as well as the usage of reinforcement materials on/in the 3D object, such as how effective a certain reinforcement material has used on the 3D object.

3D printers(s) 250 may be any device capable of constructing a 3D object from a CAD model or other digital 3D model. Additionally, the 3D printer 250 may comprise one or more cameras embedded into the 3D printer 250. The 3D printer(s) 250 may comprise one or more printing nozzles that are capable of printing reinforcement material on and/or in a 3D object, also referred to as a multi-nozzle system. The 3D printer(s) 250 may comprise a spray nozzle. Additionally, the 3D printer(s) 250 may comprise an inject jet that is capable of pushing through a metal wire strip through a portion of the 3D object. Also, the 3D printer(s) 250 may comprise a mixing chamber in which multiple types of reinforcement material may be both mixed and printed together.

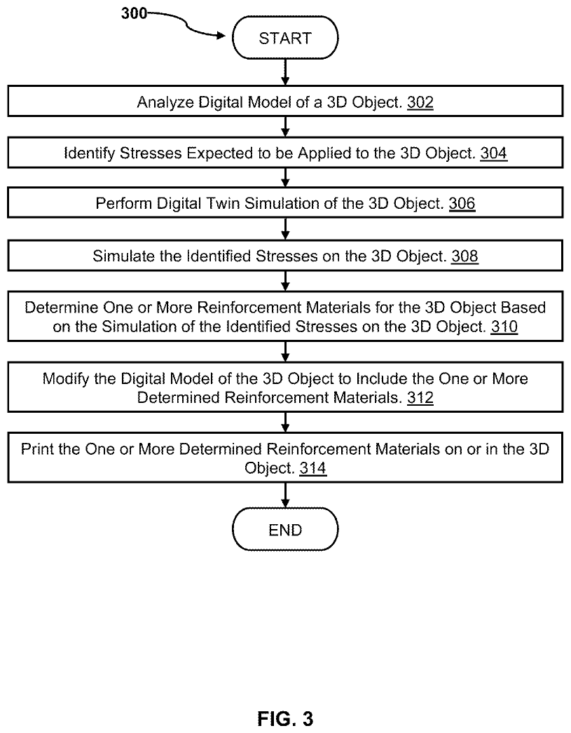

According to the present embodiment, the 3D printed object reinforcement material determination program 200 herein referred to as “the program”, may be a program capable of analyzing a digital model of a 3D object, identifying stresses that are expected to be applied to the 3D object, performing digital twin simulation of the 3D object, simulating the identified stresses on the 3D object, determining one or more reinforcement materials for the 3D object based on the simulating of the identified stresses on the 3D object, modifying the digital model of the 3D object to include the one or more determined reinforcement materials, and printing the one or more determined reinforcement materials on and/or in the 3D object. The program 200 may be located on client computing device 101 or remote server 104 or on any other device located within network 102. Furthermore, the program 200 may be distributed in its operation over multiple devices, such as client computing device 101 and remote server 104. The 3D printed object reinforcement material determination method is explained in further detail below with respect to FIG. 3.

Referring now to FIG. 3, an operational flowchart illustrating a 3D printed object reinforcement material determination process 300 is depicted according to at least one embodiment. At 302, the program 200 analyzes a digital model of a 3D object. The program 200 can analyze a digital model, such as a CAD file, of a 3D object to determine the dimensions, shape, and/or the axis of the object being 3D printed. The program 200 can receive the CAD model information through network communications 102 with a CAD program 202. A user may select a CAD model from the client computing device 101 and/or database 130 for the program 200 to analyze. A user may be any person who is using the program 200. Additionally, the program 200 can analyze the stress profile of the object being printed to determine the operational and environmental parameters of the 3D object. A digital model of a 3D object can comprise a stress profile. The stress profile of the 3D object can comprise information related to the stresses that are expected to be applied to the 3D object, such as why, when, what, and how the 3D object will be used, and the operational and environmental parameters of the 3D object. Operational parameters may comprise the types of activities the 3D object is expected to perform, and how long the 3D object is expected to perform an activity, etc. Environmental parameters may comprise information relating to the 3D object's surroundings, like temperature and humidity, etc. The program 200 can generate a digital model of the 3D object based on the analyzed CAD model of the 3D object.

At 304, the program 200 identifies the stresses that are expected to be applied to the 3D object, also referred to as the applied stresses. The program 200 can identify the applied stresses based on the expected operational and environmental parameters of the 3D object. Applied stresses may comprise the types of stresses that the 3D object is expected to experience, the direction of the stresses, and the magnitude of the stresses, over the course of the 3D object's lifetime.

At 306, the program 200 performs a digital twin simulation of the 3D object. The program 200 may perform a digital twin simulation to identify one or more reinforcement materials to print on or in the 3D object so that the 3D object will be able to withstand applied stresses over a certain period, such as the expected lifespan of the 3D object. A digital twin simulation can be a virtual representation of an object or system and is updated from real-time data and may use simulations to help decision-making. Digital twin simulation may be performed using artificial intelligence systems such as Maximo® (Maximo® and all Maximo®-based trademarks and logos are trademarks or registered trademarks of International Business Machines Corporation, and/or its affiliates). The program 200 can import the digital model of the 3D object into the digital twin simulation, herein referred to as the digital twin 3D object model. A digital twin 3D object model may comprise the same properties as the digital model of the 3D object. The program 200 may dynamically modify a digital model of the 3D model based on the modifications made to the digital twin 3D object model during the digital twin simulation. Reinforcement materials can add rigidity to a physical object and may greatly impede crack propagation of the physical object. Specifically, reinforcement materials can enforce the mechanical properties of the physical object. Reinforcement materials may comprise types of composite material, such as metal chips, metal blocks, rubber, carbon nanotube, graphene, etc. A reinforcement material may be individually printed on and/or in a 3D object. Examples of different reinforcement methods may comprise reinforcement by short fibers or whiskers, unidirectional composition using continuous fibers for reinforcement, and reinforcing using a multilayered, laminated composite made of multiple layers. Additionally, multiple types of reinforcement materials may be mixed in the 3D printer's 250 mixing chamber and may be printed in a mixture. Different types of materials and combinations may comprise certain advantages, such as less weight and/or greater strength, etc. The program 200 can determine the types of combinations of reinforcement materials and the quantity(ies) of the reinforcement materials, such as being a uniform combination or non-uniform combination, to print on and/or in a 3D object.

At 308, the program 200 simulates the identified applied stresses on the 3D object. The program 200 can simulate the identified applied stresses on the digital twin 3D object model with the digital twin 3D object comprising one or more reinforcement materials from one or more reinforcement templates. A reinforcement template may comprise different types of reinforcement materials and/or a combination of reinforcement materials. Reinforcement template(s) may be uploaded to the program 200 by a user. Reinforcement templates may be crowdsourced, based on a manufacturer's recommendations, based on industry standards, and modified by users. Additionally, a reinforcement template may comprise the usage history of the template and positive/negative ratings from users based on previous usage via a user's response to a prompt on the GUI after the completion of the 3D printing of an object. Additionally, reinforcement templates may be associated with certain cost parameters, and/or weight parameters. The program 200 can simulate the identified stresses on the digital twin 3D object model comprising the addition(s) of the reinforcement material(s) in the chosen reinforcement template. Additionally, reinforcement templates may comprise using a multi-nozzle system and/or mixing chamber. Thus, in some embodiments of the invention, the availability of using certain reinforcement templates may depend on the capabilities of the 3D printer(s) 250 connected to the program 200.

At 310, the program 200 determines one or more reinforcement materials for the 3D object based on the simulation of the identified stresses on the 3D object. The digital twin simulation can identify which reinforcement templates were used successfully to withstand the simulated identified applied stresses that the 3D object is expected to receive over a certain period, such as the 3D object's lifespan. Additionally, the digital twin simulation may identify the target areas of the 3D object to strengthen or a change in filament(s) type. The program 200 may dynamically modify the digital twin 3D object model to comprise the one or more reinforcement materials based on the successful reinforcement template. If more than one reinforcement template is successful, the program 200 may display the results to the user via a prompt on the graphical user interface (GUI). The displayed results may comprise an image of the modified digital twin 3D object, cost of reinforcement materials, amount and types of reinforcement materials used, and filaments needed. A user may select the reinforcement template to implement into the digital twin 3D object model. The program 200 may modify the digital twin 3D object model to comprise the one or more reinforcement materials in the chosen successful reinforcement template.

In some embodiments of the invention, the program 200 may evaluate the cost of applying the one or more determined reinforcement materials in the successful reinforcement templates to the 3D object. The program 200 may compare the costs of using each successful reinforcement template to one another and may select the cheapest successful reinforcement template to use. Alternatively, if the cost of using a certain reinforcement template is determined to be too costly, based on a user's response to a prompt on the GUI, the program 200 may determine if an alternate selection of reinforcement materials is available to be printed on or in the 3D object instead using a trial and error method in the digital twin simulation. The trial and error method may comprise the program 200 simulating different combinations of reinforcement material(s) in or on the 3D object to determine if one or more different combinations of reinforcement material(s) can be applied to the 3D object so that the 3D object can withstand the identified applied stresses. If the program 200 determines that using an alternate selection of reinforcement material(s) is appropriate, the program 200 may implement the alternate selection of reinforcement materials into the digital twin 3D object model.

At 312, the program 200 modifies the digital model of the 3D object to comprise the one or more determined reinforcement materials. The program 200 may modify the digital model of the 3D object based on the modification(s) to the digital twin 3D object model during the digital twin simulation. The program 200 can dynamically save the data representing the modifications and the digital model of the 3D object comprising the modifications in the database 130. The program 200 can send the modified digital model of the 3D object to the 3D printer(s) 250.

At 314, the program 200 prints the one or more determined reinforcement materials on or in the 3D object. The program 200 may feed the data representing the modified digital model of the 3D object to the 3D printer(s) 250 with instructions instructing the 3D printer(s) 250 to print the one or more determined reinforcement materials on or in the 3D object. The program 200 can print the one or more determined reinforcement materials on or in the 3D object based on the instructions the program 200 sent to the 3D printer(s) 250. The program 200 may perform a programmatic reinforcement printing method to print the 3D printed object. The program 200 can control and leverage a multi-nozzle system in a 3D printer(s) 250 to perform 3D printing. The multi-nozzle system may comprise one or more 3D printing nozzles, an inject jet, a mixing container, and a spray nozzle. The program 200 can instruct the nozzles in the multi-nozzle system separately, partially, or together. The program 200 may instruct the times at which the nozzles will print, such that the nozzles can print at the same or different times, and the order in which the nozzles will print. For example, the program 200 can instruct a multi-nozzle system to first, place certain chips or wires in an appropriate sequence, and then secondly, to spray the printed reinforcement materials with hardening material at a defined angle and at a defined speed to achieve the required level of reinforcement for the 3D object. Multiple printing nozzles may be used to print various reinforcement materials through the use of different individual filaments and/or filament mixtures loaded into each printing nozzle. Additionally, in some embodiments of the invention, the program 200 may insert a metal wire strip through a portion of the 3D object by using an inject jet. In some embodiments of the invention, the program 200 may use multiple 3D printers 250 to print the one or more determined reinforcement materials on or in the 3D object.

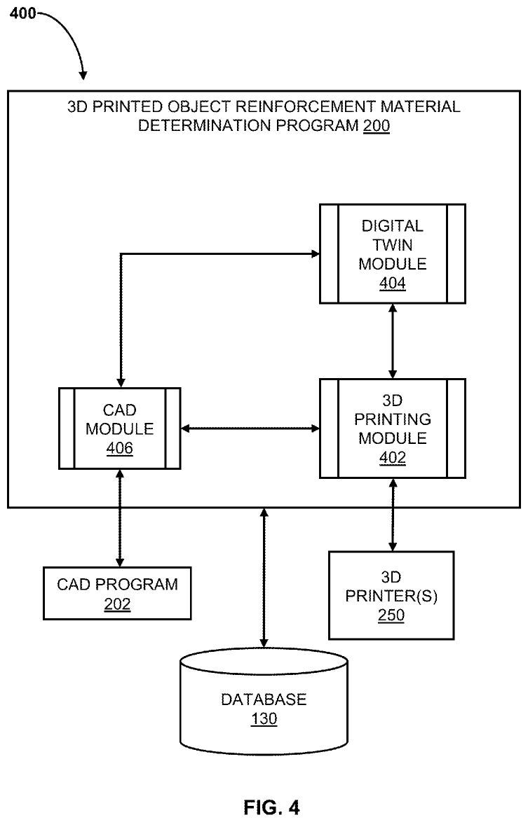

Referring now to FIG. 4, a system diagram illustrating an exemplary program environment 400 of an implementation of a 3D printed object reinforcement material determination process 300 is depicted according to at least one embodiment. Here, the program 200 comprises a 3D printing module 402, a digital twin module 404, and a CAD module 406. The exemplary program environment 400 details the interactions between the 3D printing module 402 and the digital twin module 404, the 3D printing module 402 and the CAD module 406, and the digital twin module 404 and the CAD module 406. Additionally, the exemplary program environment 400 details the interactions between the 3D printed object reinforcement material determination program 200 and the database 130, the 3D printing module 402 and the 3D printer(s) 250, and the CAD module 406 and the CAD program 202.

The 3D printing module 402 may be used to communicate with the 3D printer(s) 250. The digital twin module 404 may be used to perform a twin simulation of a 3D object. The CAD module 406 may be used to communicate with the CAD program 202.

It may be appreciated that FIGS. 2 through 4 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for 3D printing, the method comprising:
analyzing a digital model of a 3D object;
identifying stresses expected to be applied to the 3D object;
performing digital twin simulation of the 3D object;
simulating the identified stresses on the 3D object;
determining one or more reinforcement materials for the 3D object based on the simulating of the identified stresses on the 3D object;
modifying the digital model of the 3D object to include the one or more determined reinforcement materials; and
printing the one or more determined reinforcement materials on and/or in the 3D object.

2. The method of claim 1, wherein the simulating of the identified stresses on the 3D object comprises using one or more reinforcement templates during the digital twin simulation of the 3D object.

3. The method of claim 1, further comprising:
performing programmatic reinforcement of the 3D object.

4. The method of claim 3, wherein the performing of the programmatic reinforcement of the 3D object comprises using a multi-nozzle system to print the 3D object.

5. The method of claim 4, wherein the multi-nozzle system comprises one or more 3D printing nozzles, an inject jet, a mixing container, and a spray nozzle.

6. The method of claim 1, further comprising:
evaluating costs of the one or more determined reinforcement materials for the 3D object;
using a trial and error method to determine the costs of using one or more alternate reinforcement materials; and
determining an alternate selection of reinforcement materials for the 3D object based on the using of the trial and error method to determine the costs of using the one or more alternate reinforcement materials.

7. The method of claim 1, wherein the one or more reinforcement materials for the 3D object may comprise a combination of one or more reinforcement materials.

8. A computer system for 3D printing, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
analyzing a digital model of a 3D object;
identifying stresses expected to be applied to the 3D object;
performing digital twin simulation of the 3D object;
simulating the identified stresses on the 3D object;
determining one or more reinforcement materials for the 3D object based on the simulating of the identified stresses on the 3D object;
modifying the digital model of the 3D object to include the one or more determined reinforcement materials; and
printing the one or more determined reinforcement materials on and/or in the 3D object.

9. The computer system of claim 8, wherein the simulating of the identified stresses on the 3D object comprises using one or more reinforcement templates during the digital twin simulation of the 3D object.

10. The computer system of claim 8, further comprising:
performing programmatic reinforcement of the 3D object.

11. The computer system of claim 10, wherein the performing of the programmatic reinforcement of the 3D object comprises using a multi-nozzle system to print the 3D object.

12. The computer system of claim 11, wherein the multi-nozzle system comprises one or more 3D printing nozzles, an inject jet, a mixing container, and a spray nozzle.

13. The computer system of claim 8, further comprising:
evaluating costs of the one or more determined reinforcement materials for the 3D object;
using a trial and error method to determine the costs of using one or more alternate reinforcement materials; and
determining an alternate selection of reinforcement materials for the 3D object based on the using of the trial and error method to determine the costs of using the one or more alternate reinforcement materials.

14. The computer system of claim 8, wherein the one or more reinforcement materials for the 3D object may comprise a combination of one or more reinforcement materials.

15. A computer program product for 3D printing, the computer program product comprising:
one or more computer-readable tangible storage medium and program instructions stored on at least one of the one or more tangible storage medium, the program instructions executable by a processor to cause the processor to perform a method comprising:
analyzing a digital model of a 3D object;
identifying stresses expected to be applied to the 3D object;
performing digital twin simulation of the 3D object;
simulating the identified stresses on the 3D object;
determining one or more reinforcement materials for the 3D object based on the simulating of the identified stresses on the 3D object;
modifying the digital model of the 3D object to include the one or more determined reinforcement materials; and
printing the one or more determined reinforcement materials on and/or in the 3D object.

16. The computer program product of claim 15, wherein the simulating of the identified stresses on the 3D object comprises using one or more reinforcement templates during the digital twin simulation of the 3D object.

17. The computer program product of claim 15, further comprising:
performing programmatic reinforcement of the 3D object.

18. The computer program product of claim 17, wherein the performing of the programmatic reinforcement of the 3D object comprises using a multi-nozzle system to print the 3D object.

19. The computer program product of claim 18, wherein the multi-nozzle system comprises one or more 3D printing nozzles, an inject jet, a mixing container, and a spray nozzle.

20. The computer program product of claim 15, further comprising:
evaluating costs of the one or more determined reinforcement materials for the 3D object;
using a trial and error method to determine the costs of using one or more alternate reinforcement materials; and
determining an alternate selection of reinforcement materials for the 3D object based on the using of the trial and error method to determine the costs of using the one or more alternate reinforcement materials.
